(19) United States
(12) Patent Application Publication
(10) Pub. No.: US 2017/0185516 A1
(43) Pub. Date: Jun. 29, 2017

(54) SNOOP OPTIMIZATION FOR MULTI-PORTED NODES OF A DATA PROCESSING SYSTEM

(71) Applicant: ARM Limited, Cambridge (GB)

(72) Inventors: Ashley Miles STEVENS, Austin, TX (US); Andrew David TUNE, Dronfield (GB); Daniel Adam SARA, Sheffield (GB)

(73) Assignee: ARM Limited, Cambridge (GB)

(21) Appl. No.: 14/980,144

(22) Filed: Dec. 28, 2015

(51) Int. Cl. G06F 12/08; G06F 9/30; G06F 15/80; G06F 15/78

(52) U.S. Cl. CPC G06F 12/0831; G06F 15/7814; G06F 9/30036; G06F 15/8069; G06F 15/781; G06F 2212/621

(57) ABSTRACT

A data processing apparatus having an interconnect circuit operable to transfer snoop messages between a plurality of connected devices, at least one of which has multiple ports each coupled to a local cache. The interconnect circuit has decode logic that identifies, from an address in a snoop message, which port is coupled to the local cache associated with the address, and the interconnect circuit transmits the snoop message to that port. The interconnect circuit may also have a snoop filter that stores a snoop vector for each block of data in the local caches. Each snoop vector has an address tag that identifies the block of data and a presence vector indicative of which devices of the connected devices have a copy of the block of data. The presence vector does not identify which port of a device has access to the copy.

### BACKGROUND

Data processing systems, such as a System-on-a-Chip (SoC) may contain multiple processor cores, multiple data caches and shared data resources. In a shared memory system for example, each of the processor cores may read and write to a single shared address space. Cache coherency is an issue in any system that contains one or more caches and more than one device sharing data in a single cached area. There are two potential problems with a system that contains caches. Firstly, memory may be updated (by another device) after a cached device has taken a copy. At this point, the data within the cache is out-of-date or invalid and no longer contains the most up-to-date data. Secondly, systems that contain write-back caches must deal with the case where the device writes to the local cached copy at which point the memory no longer contains the most up-to-date data. A second device reading memory will see out-of-date (stale) data.

One example of a protocol for maintaining cache coherency is a snoop filter. The snoop filter monitors data accessed to the shared data resource to keep track of the most up-to-date copy. Another example of a cache coherence protocol is a snoop protocol, in which processing nodes exchange messages to track the state of local copies of data. Commonly, cache coherence protocols maintain one or more snoop caches that are used to store snoop records. Each snoop record associates a memory address tag with a snoop vector that indicates which caches have copies of data associated with the memory address. Thus, longer snoop records are needed as the number of caches in a system increases.

### BRIEF DESCRIPTION OF THE DRAWINGS

The accompanying drawings provide visual representations which will be used to more fully describe various representative embodiments and can be used by those skilled in the art to better understand the representative embodiments disclosed and their inherent advantages. In these drawings, like reference numerals identify corresponding elements.

FIG. 1 is a block diagram of a data processing system, in accordance with various representative embodiments.

FIG. 2 is a diagrammatic representation of a snoop filter, in accordance with various representative embodiments.

FIG. 3 is a diagrammatic representation of a presence vector of a snoop filter, in accordance with various representative embodiments.

FIG. 4 is a diagrammatic representation of a further presence vector of a snoop filter, in accordance with various representative embodiments.

FIG. 5A is a block diagram of decode logic, in accordance with various representative embodiments.

FIG. 5B, is a diagrammatic representation of the operation of decode logic, in accordance with various representative embodiments.

FIG. 6 is a block diagram of a snoop filter and decode logic, in accordance with various representative embodiments.

FIG. 7 is a flow chart of a method of snoop optimization, in accordance with various representative embodiments.

### DETAILED DESCRIPTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of the drawings.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

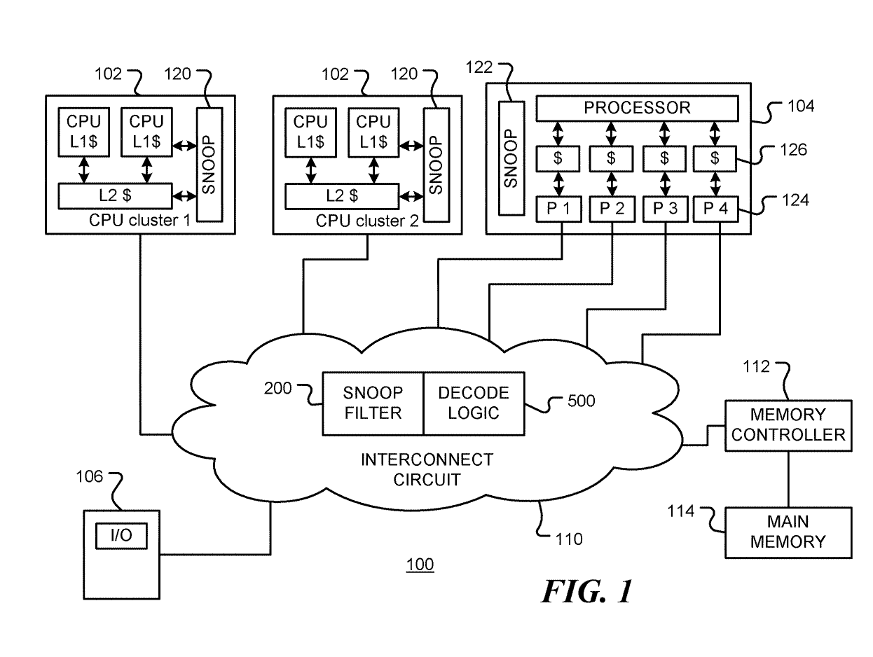

FIG. 1 is a block diagram of a data processing system 100, in accordance with various embodiments. Data processing systems, such as a System-on-a-Chip (SoC), may contain multiple processing devices, multiple data caches and shared data resources. The system 100 may be implemented in a System-on-a-Chip (SoC) integrated circuit, for example. In the simplified example shown, the system 100 is arranged as a network with a number of nodes connected together via an interconnect circuit. The nodes are functional blocks or devices, such as processors, I/O devices or memory controllers for example. As shown, the nodes include processing devices 102, 104 and 106. The devices are coupled via an interconnect circuit 110 and memory controller 112 to a shared data resource 114. The shared data resource 114 may be a memory for example.

In this example, blocks 102 each comprises a cluster of processing cores (CPU's) that share an L2 cache, with each processing core having its own L1 cache. Block 104 is a multi-ported processing unit, such as graphics processing unit (GPU), digital signal processor (DSP), field programmable gate array (FPGA) or an application specific integrated circuit (ASIC) device for example, having two or more ports. In addition, other devices such as I/O master device 106 may be included.

The blocks 102 and 104 are referred to herein as master devices that may generate requests for data transactions, such as ‘load’ and ‘store’, for example, and are end points for such transactions. Blocks 102 and 104 may access memory 114 via memory controller 112 and interconnect circuit 110. Note that many elements of a SoC, such as timers for example, have been omitted in FIG. 1 for the sake of clarity.

Cache coherency is an issue in any system that contains one or more caches and more than one device sharing data in a single data resource. There are two potential problems with a system that contains caches. Firstly, memory may be updated (by another device) after a cached device has taken a copy. At this point, the data within the cache is out-of-date or invalid and no longer contains the most up-to-date data. Secondly, systems that contain write-back caches must deal with the case where the device updates the local cached copy, at which point the memory no longer contains the most up-to-date data. A second device reading memory will see out-of-date (stale) data. Cache coherency may be maintained through the exchange of ‘snoop’ messages between the processing devices 102 and 104, for example. In some embodiments, snoop filter 200 is used to reduce the number of snoop messages by tracking which local caches have copies of data and filtering out snoop messages to other local caches.

To maintain coherence, each processing device includes a snoop control unit, 120 and 122 for example. The snoop control units issue and receive coherence requests and responses (snoop messages) via the interconnect circuit 110 from other devices.

Multi-ported processing device 104 includes two or more ports 124, each associated with a local cache 126. Cache coherency may be maintained by sending snoop messages to all of the ports 124. However, maintaining cache coherency as the number of caches increases may require an excessive number of snoop messages to be transmitted. Snoop filter 200 may be used to keep track of which port has a copy of the data, however, this may require additional memory in the snoop filter to identify which of the ports has the data.

In accordance with various aspects of the disclosure it is recognized that memory addresses may be interleaved in the multi-port processing device 104 such that no more than one of the local caches 126 can have a copy of data associated with a given address. Further, it is recognized that the mapping between address and port/cache is known, so that the port can be determined or decoded from the address.

In accordance with various embodiments of the disclosure, decode logic 500 is provided. Decode logic 500 is used to determine a snoop target for snoop messages directed towards a device with two or more ports. Snoop filter 200, if included, tracks which devices haves copies of data associated with an address, rather than tracking which individual ports have copies.

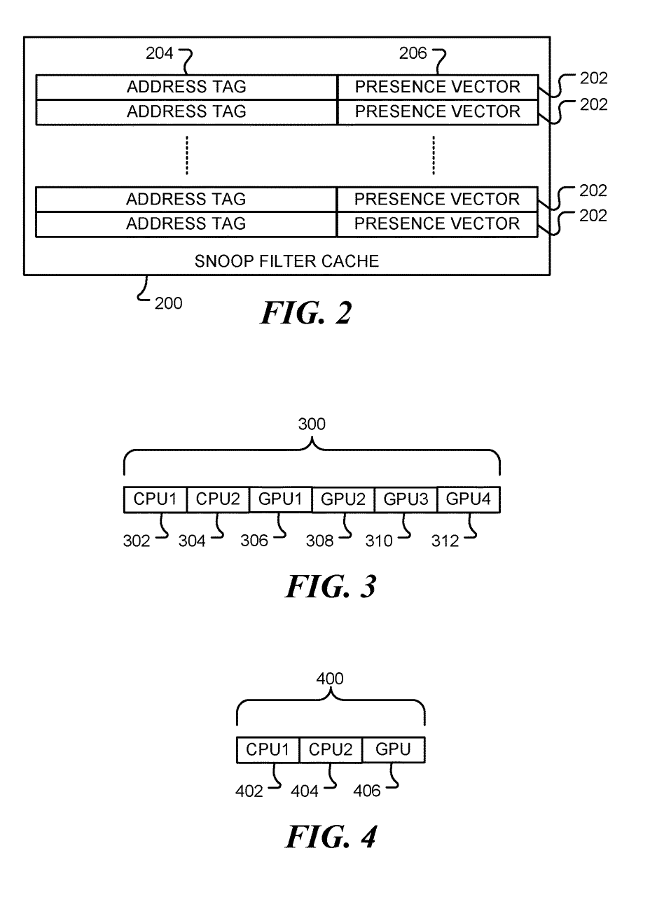

FIG. 2 is a diagrammatic representation of a snoop filter 200, in accordance with various representative embodiments. In order to maintain coherency of data in the various local caches, each cache line or block in the system is tracked and a corresponding snoop vector is maintained by the snoop filter. Each snoop vector 202 includes, at least, an address tag 204 associated with the block of cached data and a presence vector 206 that indicates which local caches of the data processing system have a copy of the data. When a snoop message for a block of data is received, the snoop filter determines which local caches have copies of the data and forwards the snoop messages, via the interconnect circuit, to the corresponding devices. If no copies are found the data is retrieved from the shared data resource.

FIG. 3 is a diagrammatic representation of a presence vector 300 of a snoop filter, in accordance with various representative embodiments. The presence vector 300 includes one bit for each cache in data processing system. A bit is set if the corresponding cache has a copy of data associated with an address tag. In this example, the presence vector 300 includes bit 302 corresponding to a first CPU cluster, bit 304 corresponding to a second CPU cluster, and bits 306, 308, 310, and 312 corresponding to four ports in a graphics processing unit.

FIG. 4 is a diagrammatic representation of a further presence vector 400 of a snoop filter, in accordance with various representative embodiments. The presence vector 400 includes one bit for each device in data processing system, rather than one bit for each cache. Thus, a bit is set if the corresponding device has a copy of data associated with an address tag in any of its local caches. In this example, the presence vector 400 includes bit 402 corresponding to a first CPU cluster, bit 404 corresponding to a second CPU cluster, and bit 406 corresponding to a graphics processing unit. Compared with the presence vector 300 shown in FIG. 3, the presence vector 400 requires less storage.

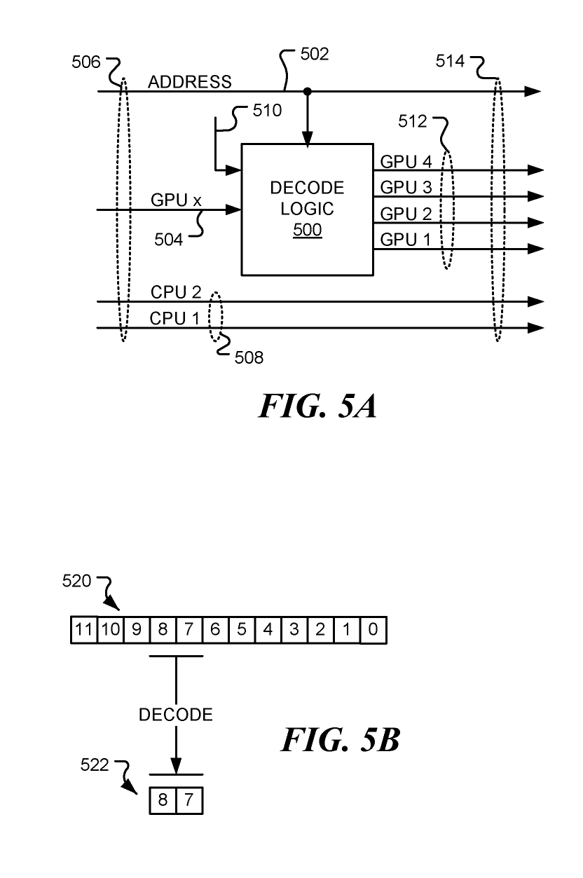

FIG. 5A is a block diagram of decode logic 500, in accordance with various representative embodiments. The decode logic is responsive to an address signal 502 and a device signal 504. The decode logic is located in an interconnect circuit that receives snoop messages 506. The snoop message 506 comprises address signal 502, device signal 504 for a multi-ported device (a graphics processing unit (GPU) in this example), and device signals 508 for other devices (central processing units CPU 1 and CPU 2, in this example). In the multi-ported device, each port is associated with a set of addresses and there is a deterministic mapping between the address and port or ports. An interleave select signal 510 may be provided to select between a number of different mappings or to indicate when memory addresses are interleaved among the ports. Accordingly, the decode logic 500 decodes the address 502 to determine port signals 512. The port signals indicate which port (or ports) the snoop message should be forwarded to and are included in modified snoop message 514 along with the device signals 508 and address signal 502. Since the modified snoop message is routed through the interconnect circuit only to a port associated with the address, the number of snoop messages in the interconnect is reduced.

In applications where data is interleaved between the ports in a block of 2^{N} elements, an address may be decoded by considering selected bits in the address. For example, when four ports are used, bits N+1 and N together indicate the port to which a snoop message should be routed. This is illustrated in FIG. 5B for blocks of size 128 (2⁷) interleaved between four ports. In this example, a 12-bit address 520 is decoded by extracting bits 7 and 8 to give a two-bit identifier 522 of the associated port. A two-port device would use a single bit from the address, while an 8-port device would use 3 bits from the address. Other decode methods may be used depending upon how memory is allocated between the ports.

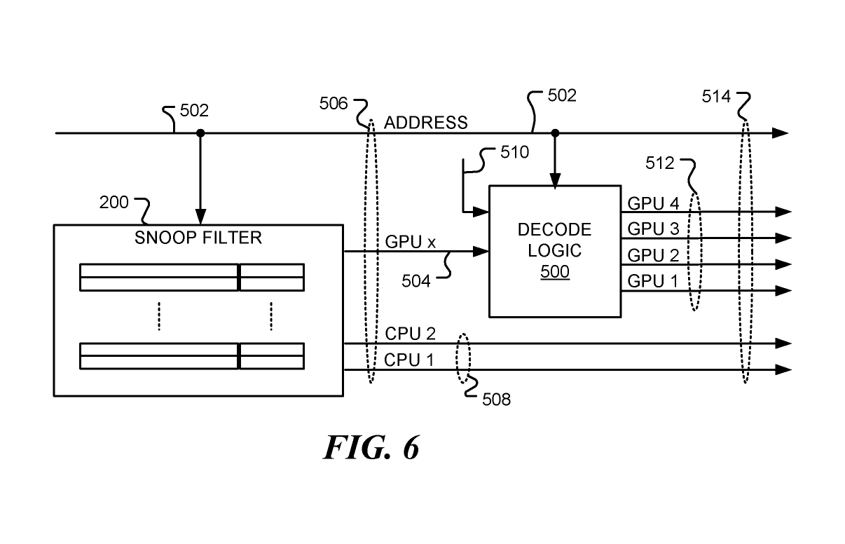

FIG. 6 is a block diagram of a snoop filter 200 and decode logic 500, in accordance with various representative embodiments. The decode logic 500 operates as discussed above with reference to FIG. 5, The snoop filter 200 is responsive to address signal 502 and outputs signals 504 and 508 indicative of which devices of the data processing system have a copy of the data associated with the address signal in a local cache. Use of snoop filter 200 reduces the number of snoop messages still further, since snoop messages are only sent to devices known to have a copy of the data in their local cache. Further, if the device is a multi-ported device, a snoop message is only sent to the port (or ports) having a copy of the data in their local cache.

The use of decode logic 500 enables the presence vector in the snoop vector to be shorter. This results in a significant memory saving when a large number of snoop vectors are stored. Thus, the combination of snoop filter 200 and decode logic 500 provides an optimized apparatus for snoop messaging in a data processing system.

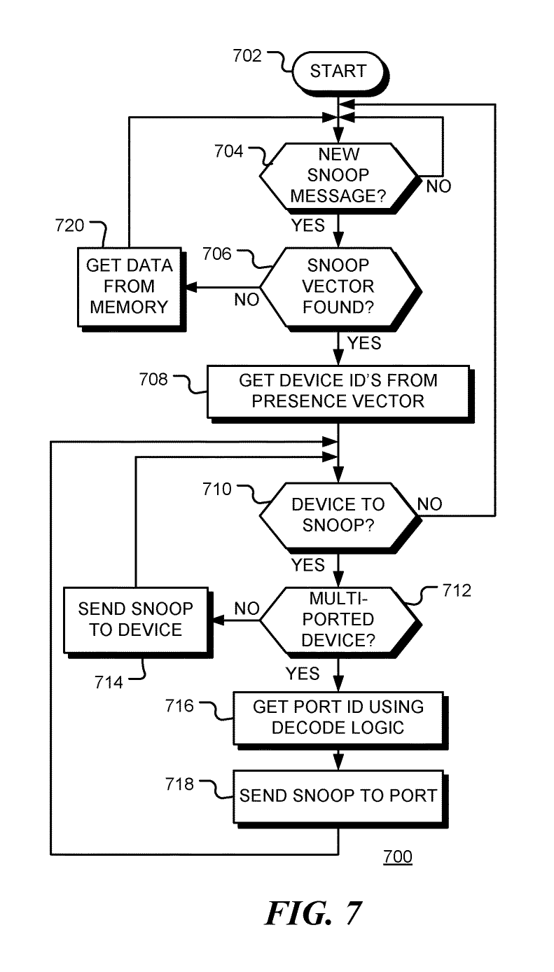

FIG. 7 is a flow chart 700 of a method of snoop optimization, in accordance with various representative embodiments. Following start block 702 in FIG. 7, flow remains at decision block 704 until, as indicated by the positive branch from decision block 704, a new snoop message is received. Upon receipt of the snoop message, a snoop filter is accessed, using an address tag in the snoop message to find a corresponding snoop vector. If a snoop vector associated with the address tag is found, as depicted by the positive branch from decision block 706, the presence vector is accessed, at block 708, to determine identifiers of devices that share a copy of data associated with the address tag. A snoop message is then sent to each device that shares the data. This may be done parallel or, as depicted in flow chart 700, in series. A determination is made at decision block 710 if any more devices are to be snooped. If another device is to be snooped, as depicted by the positive branch from decision block 710, flow continues to decision block 712, otherwise all devices have been snooped and flow returns to block 704. If another device is to be snooped, a determination is made, at decision block 712, if the device is a multi-ported device. If the device is not multi-ported, as depicted by the negative branch from decision block 712, and a snoop is forwarded to the device at block 714. If the device is multi-ported, as depicted by the positive branch from decision block 712, decode logic is used at block 716 to determine which port (or ports) of the device should be snooped and a snoop is forwarded only to the identified port at block 718. Flow then returns to decision block 710. If the address tag is not found in the snoop filter, as depicted by the negative branch from decision block 706, the data may be retrieved from memory at block 720. In this manner, snoop messages are only sent to devices or ports of devices that have a copy of the data associated with the address and the memory requirement of the snoop filter is reduced.

While a method and apparatus for snoop optimization has been described above with reference to a multi-ported device, the method and apparatus has application to any data processing system for which a deterministic mapping exists between an address and one or more caches to be snooped. The caches may be in the same device, as discussed above, or in different devices. For example, if CPU clusters 102 in FIG. 1 operated on distinct sets of addresses, they could be grouped together and share a single bit in the presence vector. Decode logic could be used to determine which device should be snooped. Thus, the two CPU clusters may be considered as a single multi-ported device in this example.

Accordingly, a multi-ported device is considered herein to be a device or group of devices, with multiple local caches, for which there exists a deterministic mapping between an address and a cache in which associated data can be stored.

The deterministic mapping may map each address to a single port or the deterministic mapping may map each address to two or more ports.

Those skilled in the art will recognize that the present invention may be implemented using a programmed processor, reconfigurable hardware components, dedicated hardware components or combinations thereof. Similarly, general purpose computers, microprocessor based computers, micro-controllers, optical computers, analog computers, dedicated processors and/or dedicated hard wired logic may be used to construct alternative equivalent embodiments of the present invention.

Dedicated or reconfigurable hardware components may be described by instructions of a Hardware Description Language. These instructions may be stored on non-transient computer readable medium such as Electrically Erasable Programmable Read Only Memory (EEPROM); non-volatile memory (NVM); mass storage such as a hard disc drive, floppy disc drive, optical disc drive; optical storage elements, magnetic storage elements, magneto-optical storage elements, flash memory, core memory and/or other equivalent storage technologies without departing from the present invention. Such alternative storage devices should be considered equivalents.

Thus, in accordance with various embodiments, the present disclosure provides a data processing apparatus comprising an interconnect circuit operable to transfer snoop messages between a plurality of devices coupled by the interconnect circuit, the interconnect circuit comprising decode logic, where a snoop message comprises an address in a shared data resource, where a first processing device of the plurality of devices comprises a plurality of first ports coupled to the interconnect circuit and a plurality of local caches, each coupled to a first port of the plurality of first ports and each associated with a set of addresses in the shared data resource, where the decode logic identifies, from an address in the snoop message, a first port of the first of second ports that is coupled to the local cache associated with the address, and where the interconnect circuit transmits the snoop message to the identified first port.

The interconnect circuit may also include a snoop filter having a snoop filter cache operable to store a snoop vector for each block of data in a local cache of the first processing device. A snoop vector comprises an address tag that identifies the block of data and a presence vector indicative of which devices of the plurality of devices has a copy of the block of data, where the interconnect circuit does not transmit the snoop message to any port of the first processing device unless the presence vector indicates that the first processing device has a copy of the block of data in a local cache. The presence vector contains one data bit for each of the plurality of devices.

The data processing apparatus may also include a memory controller, where the shared data resource comprises a memory accessible via the memory controller. The first processing device may be, for example, a graphic processing unit (GPU), a digital signal processor (DSP), a field programmable gate array (FPGA) or an application specific integrated circuit (ASIC) device.

The decode logic may be configured to identify the first port from the address in accordance with a map. Optionally, the map may be selected from a plurality of maps in response to an interleave select signal. An interleave select signal may also indicate whether to not addresses are interleaved between ports. When not interleaved, or when the address cannot be decoded, snoop messages may be sent to all of the ports.

In accordance with further embodiments there is provided a data processing apparatus having a first device comprising a first local cache operable to store data associated with a first set of addresses in a shared data resource, a second device comprising a second local cache operable to store data associated with a second set of addresses in the shared data resource, decode logic responsive to an address in the shared data resource to provide an output indicative of whether the address is in the first set of addresses or in the second set of addresses; and an interconnect circuit operable to transfer a message, containing the address, to the first device when the address is indicated to be in the first set of addresses and operable to transfer the message containing the address to the second device when the address is indicated to be in the second set of addresses.

The data processing apparatus may also include a plurality of third devices coupled to the interconnect circuit and a snoop filter. The snoop filter includes a memory configured to store a plurality of snoop vectors, each snoop vector containing an address tag and a presence vector. The presence vector contains of one bit for each of the plurality of third processing devices and one bit for the first and second devices, where the one bit for the first and second processing devices is set if either of the first and second caches stores a copy of data associated with the address tag. The first and second sets of addresses may be interleaved.

Various embodiments relate to a method of data transfer in a data processing apparatus having a shared data resource accessible by a plurality of devices, where a first device of the plurality of devices has a plurality of first ports and a plurality of first caches each associated with a first port of the plurality of first ports. Responsive to a message containing an address in the shared data resource, the address is decoded to identify a first cache of the plurality of first caches that is configured to store a copy of data associated with the address; and the message is transmitted to a first port of the plurality of first ports associated with the identified first cache. The message may be a snoop message for example, such as a snoop request or snoop response. The snoop message is generated by another device of the plurality of devices. A set of devices that each have a copy of data associated with the address may be identified from a snoop vector stored in a snoop filter, and the message is transmitted to a device of the identified set of devices when the device is not a multi-ported device. Decoding the address to identify the first cache of the plurality of first caches that is configured to store the copy of data associated with the address is performed when a device of the identified set of devices is a multi-ported device.

The set of devices that have a copy of data associated with the address is identified identifying a snoop vector containing an address tag corresponding to the address and accessing a presence vector of the identified snoop vector. A single bit in a presence vector of a snoop vector when data is loaded into any first cache of the plurality of first caches.

Decoding the address to identify the first cache of the plurality of first caches associated with the address may be performed by mapping the address to an identifier of the first cache. Further, transmitting the message to the first port of the plurality of first ports associated with the identified first cache may be performed by routing the message through an interconnect circuit that couples between the plurality of devices.

The various representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

Accordingly, some aspects and features of the disclosed embodiments are set out in the following numbered items:

1. A data processing apparatus comprising:
an interconnect circuit operable to transfer snoop messages between a plurality of devices coupled by the interconnect circuit, the interconnect circuit comprising decode logic;
   where a snoop message comprises an address in a shared data resource,
   where a first processing device of the plurality of devices comprises a plurality of first ports coupled to the interconnect circuit and a plurality of local caches, each coupled to a first port of the plurality of first ports and each associated with a set of addresses in the shared data resource,
   where the decode logic identifies, from an address in the snoop message, a first port of the first of second ports that is coupled to the local cache associated with the address, and
   where the interconnect circuit transmits the snoop message to the identified first port.
   2. The data processing apparatus of item 1, where the interconnect circuit further comprises a snoop filter, the snoop filter comprising:
a snoop filter cache operable to store a snoop vector for each block of data in a local cache of the first processing device, a snoop vector comprising:
   an address tag that identifies the block of data; and
   a presence vector indicative of which devices of the plurality of devices has a copy of the block of data,
      where the interconnect circuit does not transmit the snoop message to any port of the first processing device unless the presence vector indicates that the first processing device has a copy of the block of data in a local cache.
      3. The data processing apparatus of item 2, where the presence vector consists of one data bit for each of the plurality of devices.
      4. The data processing apparatus of item 1, further comprising a memory controller, where the shared data resource comprises a memory accessible via the memory controller.
      5. The data processing apparatus of item 1, further comprising the plurality of devices.
      6. The data processing apparatus of item 5, where the first processing device is selected from a group of processing devices consisting of a graphic processing unit (GPU), a digital signal processor (DSP), a field programmable gate array (FPGA) and an application specific integrated circuit (ASIC) device.
      7. The data processing apparatus of item 5, where the data processing apparatus consists of an integrated circuit.
      8. The data processing apparatus of item 5, where the decode logic is configured to identify the first port from the address in accordance with a map.
      9. The data processing apparatus of item 8, where the decode logic is responsive to an interleave select signal that selects the map from a plurality of maps or indicates when the addresses are interleaved between the plurality of first ports.
      10. A System-on-a-Chip comprising the data processing apparatus of item 5.
      11. A non-transient computer readable medium containing instructions of a Hardware Description Language that define the data processing apparatus of item 1.
      12. A data processing apparatus comprising:
a first device comprising a first local cache operable to store data associated with a first set of addresses in a shared data resource;
a second device comprising a second local cache operable to store data associated with a second set of addresses in the shared data resource;
decode logic responsive to an address in the shared data resource to provide an output indicative of whether the address is in the first set of addresses or in the second set of addresses; and
an interconnect circuit operable to transfer a message containing the address to the first device when the address is indicated to be in the first set of addresses and operable to transfer the message containing the address to the second device when the address is indicated to be in the second set of addresses.
   13. The data processing apparatus of item 12, further comprising:
a plurality of third devices coupled to the interconnect circuit; and
a snoop filter, where the snoop filter comprises a memory configured to store a plurality of snoop vectors, where a snoop vector comprises an address tag and a presence vector, the presence vector consisting of one bit for each of the plurality of third processing devices and one bit for the first and second devices, where the one bit for the first and second processing devices is set if either of the first and second caches stores a copy of data associated with the address tag.
   14 The data processing apparatus of item 12, where the first and second sets of addresses are interleaved.
   15. A System-on-a-Chip (SoC) comprising the data processing apparatus of item 12.
   16. A method of data transfer in a data processing apparatus having a shared data resource accessible by a plurality of devices, a first device of the plurality of devices comprising a plurality of first ports and a plurality of first caches each associated with a first port of the plurality of first ports, the method comprising:
responsive to a message containing an address in the shared data resource:
   decoding the address to identify a first cache of the plurality of first caches that is configured to store a copy of data associated with the address; and
   transmitting the message to a first port of the plurality of first ports associated with the identified first cache.
      17. The method of item 16 where the message comprises a snoop message, the method further comprising generating the snoop message by a second device of the plurality of devices.
      18. The method of item 17, further comprising:
identifying, from one or more snoop vectors, a set of devices of the plurality of device that each have a copy of data associated with the address; and
transmitting the message to a device of the identified set of devices when the device is not a multi-ported device,
   where decoding the address to identify the first cache of the plurality of first caches that is configured to store the copy of data associated with the address is performed when a device of the identified set of devices is a multi-ported device.
   19. The method of item 18, where identifying, from the one or more snoop vectors, the set of devices of plurality that have a copy of data associated with the address comprises:
identifying a snoop vector containing an address tag corresponding to the address; and
accessing a presence vector of the identified snoop vector.
   20. The method of item 18, further comprising:
setting a single bit in a presence vector of a snoop vector when data is loaded into any first cache of the plurality of first caches.
   21. The method of item 16, where decoding the address to identify the first cache of the plurality of first caches associated with the address comprises mapping the address to an identifier of the first cache.
   22. The method of item 16, where transmitting the message to the first port of the plurality of first ports associated with the identified first cache comprises routing the message through an interconnect circuit that couples between the plurality of devices.

What is claimed is:

1. A data processing apparatus comprising:
an interconnect circuit operable to transfer snoop messages between a plurality of devices coupled by the interconnect circuit, the interconnect circuit comprising decode logic;
where a snoop message comprises an address in a shared data resource,
where a first processing device of the plurality of devices comprises a plurality of first ports coupled to the interconnect circuit and a plurality of local caches, each coupled to a first port of the plurality of first ports and each associated with a set of addresses in the shared data resource,
where the decode logic identifies, from an address in the snoop message, a first port of the first of second ports that is coupled to the local cache associated with the address, and
where the interconnect circuit transmits the snoop message to the identified first port.

2. The data processing apparatus of claim 1, where the interconnect circuit further comprises a snoop filter, the snoop filter comprising:
a snoop filter cache operable to store a snoop vector for each block of data in a local cache of the first processing device, a snoop vector comprising:
an address tag that identifies the block of data; and
a presence vector indicative of which devices of the plurality of devices has a copy of the block of data,
where the interconnect circuit does not transmit the snoop message to any port of the first processing device unless the presence vector indicates that the first processing device has a copy of the block of data in a local cache.

3. The data processing apparatus of claim 2, where the presence vector consists of one data bit for each of the plurality of devices.

4. The data processing apparatus of claim 1, further comprising a memory controller, where the shared data resource comprises a memory accessible via the memory controller.

5. The data processing apparatus of claim 1, further comprising the plurality of devices.

6. The data processing apparatus of claim 5, where the first processing device is selected from a group of processing devices consisting of a graphic processing unit (GPU), a digital signal processor (DSP), a field programmable gate array (FPGA) and an application specific integrated circuit (ASIC) device.

7. The data processing apparatus of claim 5, where the data processing apparatus consists of an integrated circuit.

8. The data processing apparatus of claim 5, where the decode logic is configured to identify the first port from the address in accordance with a map.

9. The data processing apparatus of claim 8, where the decode logic is responsive to an interleave select signal that selects the map from a plurality of maps or indicates when the addresses are interleaved between the plurality of first ports.

10. A System-on-a-Chip comprising the data processing apparatus of claim 5.

11. A non-transient computer readable medium containing instructions of a Hardware Description Language that define the data processing apparatus of claim 1.

12. A data processing apparatus comprising:
a first device comprising a first local cache operable to store data associated with a first set of addresses in a shared data resource;
a second device comprising a second local cache operable to store data associated with a second set of addresses in the shared data resource;
decode logic responsive to an address in the shared data resource to provide an output indicative of whether the address is in the first set of addresses or in the second set of addresses; and
an interconnect circuit operable to transfer a message containing the address to the first device when the address is indicated to be in the first set of addresses and operable to transfer the message containing the address to the second device when the address is indicated to be in the second set of addresses.

13. The data processing apparatus of claim 12, further comprising:
a plurality of third devices coupled to the interconnect circuit; and
a snoop filter, where the snoop filter comprises a memory configured to store a plurality of snoop vectors, where a snoop vector comprises an address tag and a presence vector, the presence vector consisting of one bit for each of the plurality of third processing devices and one bit for the first and second devices, where the one bit for the first and second processing devices is set if either of the first and second caches stores a copy of data associated with the address tag.

14. The data processing apparatus of claim 12, where the first and second sets of addresses are interleaved.

15. A System-on-a-Chip (SoC) comprising the data processing apparatus of claim 12.

16. A method of data transfer in a data processing apparatus having a shared data resource accessible by a plurality of devices, a first device of the plurality of devices comprising a plurality of first ports and a plurality of first caches each associated with a first port of the plurality of first ports, the method comprising:
responsive to a message containing an address in the shared data resource:
decoding the address to identify a first cache of the plurality of first caches that is configured to store a copy of data associated with the address; and
transmitting the message to a first port of the plurality of first ports associated with the identified first cache.

17. The method of claim 16 where the message comprises a snoop message, the method further comprising generating the snoop message by a second device of the plurality of devices.

18. The method of claim 17, further comprising:
identifying, from one or more snoop vectors, a set of devices of the plurality of device that each have a copy of data associated with the address; and
transmitting the message to a device of the identified set of devices when the device is not a multi-ported device,
where decoding the address to identify the first cache of the plurality of first caches that is configured to store the copy of data associated with the address is performed when a device of the identified set of devices is a multi-ported device.

19. The method of claim 18, where identifying, from the one or more snoop vectors, the set of devices of plurality that have a copy of data associated with the address comprises:
identifying a snoop vector containing an address tag corresponding to the address; and
accessing a presence vector of the identified snoop vector.

20. The method of claim 18, further comprising:
setting a single bit in a presence vector of a snoop vector when data is loaded into any first cache of the plurality of first caches.

21. The method of claim 16, where decoding the address to identify the first cache of the plurality of first caches associated with the address comprises mapping the address to an identifier of the first cache.

22. The method of claim 16, where transmitting the message to the first port of the plurality of first ports associated with the identified first cache comprises routing the message through an interconnect circuit that couples between the plurality of devices.
